(19) United States
(12) Patent Application Publication
(10) Pub. No.: US 2008/0014138 A1
(43) Pub. Date: Jan. 17, 2008

(54) Methods of synthesizing glitter

(76) Inventor: Michael J. Bucknum, Oceanside, CA (US)

Correspondence Address: Michael J. Bucknum, PhD, 3380 Harding St., #14A, Carlsbad, CA, 92008, US

(21) Appl. No.: 11/784,588

(22) Filed: Apr. 9, 2007

Related U.S. Application Data
(60) Provisional application No. 60/800,262, filed on May 15, 2006.
(60) Provisional application No. 60/808,373, filed on May 26, 2006.

(51) Int. Cl. C01B 31/00; C01B 33/00

(52) U.S. Cl. 423/414; 423/324

(57) ABSTRACT

In the carbon science literature, there have been various reports over the previous few decades of potentially novel crystalline forms of carbon emerging as nanometer scale fragments recovered from the explosive remnants of heated, shock compressed graphite and other precursors of C. Two nanometric and crystalline forms of C that are particularly prominent in these studies are the so-called n-diamond and i-carbon forms. In previous work by us, we have shown that the commonly observed diffraction pattern of n-diamond nanocrystals recorded by several research groups around the world, is consistent with the calculated diffraction pattern of a novel form of carbon we have proposed called glitter. Glitter is a tetragonal allotrope of carbon with a calculated density of about 3.08 g/cm³, and the density functional theory (DFT-CASTEP) optimized lattice parameters given as a=0.2560 nm and c=0.5925 nm. In addition to the diffraction evidence for n-diamond having the glitter structure, the calculated band structure of glitter (DFT-CASTEP) shows it to be metallic, like the observed electrical characteristics of n-diamond. In this communication, we report on a comparison of the diffraction pattern observed for nanocrystalline i-carbon by the investigative team of Yamada et al. in 1994, with the calculated diffraction pattern of glitter based upon lattice parameters optimized using the DFT-CASTEP method by Pickard et al. as was reported, separately, in the n-diamond comparison described above, in 2005. The close fit of the latter dataset to that observed for i-carbon, as reported herein, suggests that indeed i-carbon may be of the same structure as n-diamond, and that they both may have the tetragonal glitter structure.

### CROSS REFERENCES TO RELATED APPLICATIONS

This application is derived from provisional patent application (PPA) Ser. No. 60,800,262 filed May 15, 2006 and provisional patent application (PPA) Ser. No. 60,808,373 filed May 26, 2006.

### STATEMENT REGARDING FEDERALLY SPONSORED RESEARCH OR DEVELOPMENT

“Not Applicable”

### REFERENCE TO SEQUENCE LISTING, A TABLE OR A COMPUTER PROGRAM LISTING CD APPENDIX

“Not Applicable”

### BACKGROUND OF INVENTION

Yamada et al. in a report issued in 1994 [1] describe the synthesis and analysis of diamond-like C nanocrystals called n-diamond and i-carbon. The synthetic method they use, involving detonation of highly explosive (RDX)/graphite mixtures (RDX=trimethylenetrinitramine) in a 1 m³ steel chamber, is, in some ways, reminiscent of earlier and later work on the synthesis of these novel forms of C by various other blunt-force methods. Therefore, as Yamada et al. report, i-carbon/n-diamond thin films have been produced by ion-beam deposition methods [2, 3] and by radiofrequency plasma decomposition of hydrocarbon gases [4]. Similarly, i-carbon/n-diamond nanocrystals have been produced by shock compression techniques [5] and by plasma chemical vapor deposition methods [6].

In the work of Yamada et al. [1] the detonation of the (RDX)/graphite mixtures in a 1 m³ steel chamber, was accompanied by a rapid cooling process to quench the diamond-like C nanocrystals of n-diamond and i-carbon in their ambient form, and to prevent the kinetics of reversion of these carbon forms into the energetically favorable polytypic forms of cubic- and hexagonal-diamond [7, 8]. The resulting nanometer-sized, spherical particles of diamond-like carbon, including intermediates, were thus found in the detonation product.

Within their mixture of crystalline C forms, Yamada et al. recovered spherical particles of i-carbon/n-diamond approximately 25 nm in diameter from the (RDX)/graphite detonation mixture, and they were analyzed by energy dispersive x-ray elemental analysis (EDX) and found to be entirely composed of C. The crystalline structure of the nanometric, spherical i-carbon/n-diamond particles was investigated with the method of high resolution electron microscopy (HREM) and diffraction patterns were obtained of the diamond-like i-carbon/n-diamond nanocrystals.

The purpose of the present communication is to account for the structure of the i-carbon/n-diamond material based upon a proposed C allotropic structure for it, called glitter [9], that has been described already previously in connection with the probable structure of the n-diamond C form in separate work [10]. In the structural proposal for n-diamond, as in the structure proposed for i-carbon/n-diamond in this communication, the experimental evidence from diffraction is used in a comparison fit to the calculated structural data (Bragg spacings of the structure) for the hypothetical glitter structure, in order to demonstrate the internal consistency between the diffraction dataset from the i-carbon/n-diamond work, and the calculated, theoretical diffraction dataset from glitter. In the latter glitter diffraction dataset, the lattice parameters have been optimized by a density functional theory (DFT-CASTEP) optimization on glitter by Pickard et al. [11].

### BRIEF SUMMARY OF THE INVENTION

Using high resolution electron microscopy (HREM) Yamada et al. investigated the internal structure of the nanocrystalline n-diamond and i-carbon spherical particles they recovered from the detonation of (RDX)/graphite mixtures, using a rapid cooling technique [1]. In this paper, we concentrate on the results obtained from diffraction analysis of the i-carbon/n-diamond material, as a similar structural comparison with the Bragg spacings of n-diamond, reported by Hirai et al. [5] in 1991, to that calculated for glitter, has been reported previously [10] as discussed above. Therefore, the nanocrystalline i-carbon/n-diamond samples were characterized by collecting electron diffraction patterns of selected areas as well as by high-resolution lattice images of the i-carbon/n-diamond nanocrystals.

The team of Yamada et al. [1] thus observed spherical particles in low-magnification HREM, in addition to needle-like, thin plates consisting of fine grains. As they report [1], the electron diffraction patterns of the samples consisted of strong, spotty rings. The complete experimental electron diffraction dataset for i-carbon, only, is shown together with the calculated d-spacings for the glitter model, based upon lattice parameters optimized by the DFT-CASTEP method, as described below, in Table 1. It is clear from the comparison provided from Table 1 below, that indeed i-carbon has the tetragonal glitter structure discussed below, as does the n-diamond carbon form.

### BRIEF DESCRIPTION OF DRAWINGS

FIG. 1: A general perspective on the glitter unit cell

FIG. 2: An extended view of glitter in 3 dimensions

FIG. 3: Resonance structures of graphite in 2 dimensions

FIG. 4: Resonance structures of glitter in 3 dimensions

### DETAILED DESCRIPTION OF THE INVENTION

Glitter was first proposed as a potential form of C in 1994 by one of us, and Hoffmann [9]. The original intent of this theoretical work was to construct a plausible model of C that combined the archetypal trigonal planar, 3-connected bonding of C in graphite with that archetypal tetrahedral, 4-connected bonding of C in diamond. Such a material is known as a 3-,4-connected C network, or alternatively it is described as a graphite-diamond hybrid. Because of its topology, the glitter structure is known as a Wellsean network, or topologically irregular network, as distinct from the semi-regular Archimedean and Catalan networks, first described by Wells [12]. From a strict adherence to the bonding character of graphite and diamond, in which the C atoms exist in 6-membered polygonal circuits in each respective structure, graphite-diamond hybrids should be Catalan networks with a connectivity that is an admixture of 3- and 4-connectedness, and a polygonal circuitry throughout the network of precisely 6. The generic Wells point symbol for such a family of related Catalan networks is given as (6⁶)ₓ(6³)_{y}, where “x” and “y” identify the stoichiometry of the net, and y/x is the ratio of 3-connected to 4-connected points in the unit cell [13]. The corresponding Schlaefli symbol for these networks is written out in the following manner as (6, 3^{X/X+Y}), where “x” is just the number of 4-connected vertices in the unit cell, and “x+y” is the number of vertices in the unit cell [13].

It can be seen from such notation that the Schlaefli symbols for the graphite-diamond hybrids can range in limits from (6, 3), which is the corresponding symbol for the graphene sheet, to (6, 4), which is the symbol for the diamond polytypes. Such graphite-diamond hybrid, Catalan networks comprise an infinite family of related structures possessing orthorhombic space group symmetry, and they have been described previously by Balaban et al. [14] and are likely candidates for the structure of many novel carbon forms.

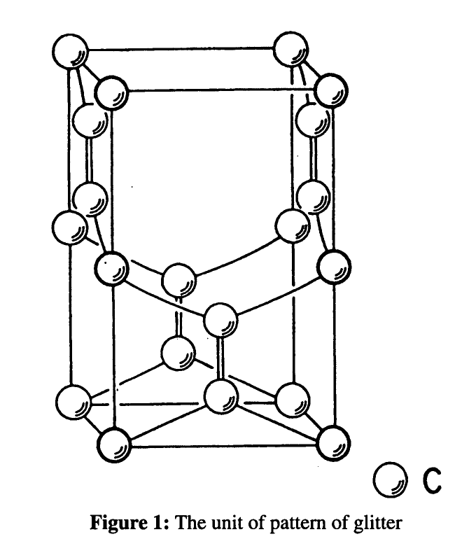

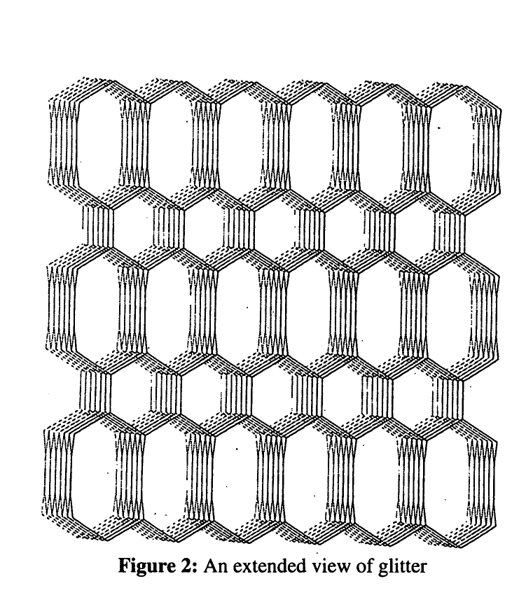

The unit cell of glitter is shown in FIG. 1, it consists of 6 atoms including 2 tetrahedral atoms and 4 trigonal planar atoms. The lattice lies in the tetragonal space group P4₂/mmc, #131. In contrast to the graphite-diamond hybrids described above, it has the Wells point symbol (6²8⁴)(6²8)₂ and therefore a Schlaefli symbol can be derived from this as (7, 3^{1/3}) [13]. From the Wells point symbol for glitter, we know that it is a Wellsean network as opposed to the infinite family of Catalan networks that comprise the true graphite-diamond hybrids of Balaban et al. [14]. Shown in FIG. 2 is an extended structural drawing of glitter, one can see the characteristic 3- and 4-connectedness of the network, in the strictly 6-gon and 8-gon circuits in its structural pattern. The net was derived, in the first instance, by extending the hydrocarbon fragment molecule 1,4-cyclohexadiene in 1-, 2- and 3-dimensions, to generate the full crystalline pattern.

In 2005, Pickard et al. performed a geometry optimization of the glitter structure using the CASTEP computational code [11] that is based upon density functional theory (DFT) [15]. The resulting optimization calculation performed under the local density approximation (LDA) showed that glitter was energetically 0.511 eV/C atom above that of the graphite lattice. A similar calculation on Buckminsterfullerene shows that it is 0.3 eV/C atom in stability above that of graphite [11]. We know from the ubiquity of the fullerenes that such an energetic deficit does not preclude their existence. The authors, of course, hold similar views concerning the potential existence of glitter. Certainly, the energetic deficit of 0.511 eV/C atom in glitter suggests that it may not easily form, but because of the unique 3-,4-connectedness of glitter, kinetic barriers to its decomposition to graphite or diamond, based upon the reconstructive nature of such a structural transition, support the contention that it would persist if it was created [16].

The geometric optimization of Pickard et al. on glitter using the CASTEP code [11] yielded a reliable set of lattice parameters for the glitter model as a=0.2560 nm and c=0.5925 nm. The optimization calculation also yielded an accurate set of bond lengths and bond angles for the glitter structure. We know from this work that the carbon-carbon single bonds are reasonable at a 0.15202 nm length, and the carbon-carbon double bonds are also normal at 0.13300 nm. The C—C—C tetrahedral angle is slightly distorted from ideality at 115°, and the C—C═C trigonal angle is 122.5°. All of this is consistent with the model originally proposed for glitter by Bucknum et al., in which the experimentally determined 1,4-cyclohexadiene molecular dimensions were used in the computation of the unit cell parameters, and which is diagrammed generically in FIG. 1 [9]. The coordinates of the 6 atoms in the glitter unit cell are listed in Table 2. From the CASTEP-DFT optimized lattice parameters, we may calculate a diffraction pattern for glitter theoretically and compare it directly to the experimental electron diffraction pattern obtained for i-carbon by Yamada et al. [1] as shown in Table 1.

From the data in Table 1, we can conclude that the match between the diffraction pattern of i-carbon, shown in the second column of Table 1, as reported by Yamada et al. [1], is entirely consistent with the diffraction pattern of glitter as calculated from the DFT-CASTEP optimized lattice parameters, described above [11] as a=0.2560 nm and c=0.5925 nm. The average deviation over the entire set of 9 matched observations is given as 0.0040 nm/reflection (or 0.0401 Å/reflection). The only outlier in the entire dataset is from the i-carbon reflection recorded at 0.2120 nm, which has a closest fit to the (003) reflection of glitter at 0.1975 nm, giving rise to the largest deviation of the dataset at 0.0145 nm. It has already been pointed out previously [17] that the (003) reflection of tetragonal glitter is a symmetry forbidden reflection, that leaves further doubt as to the potential match of this set of reflections.

Yet the other 8 reflections in the dataset have an average deviation of much less than 0.0040 nm/reflection (or 0.0401 Å/reflection), which indicates a remarkably close fit to the set of reflections recorded for i-carbon in this work [1]. The standard deviation over the entire set of 9 reflections, σₓ, is 0.0043 nm/reflection (or 0.0432 Å/reflection), which demonstrates that the dataset has a very high degree of internal consistency. In this instance, the outlier pair of reflections, consisting of the reflection observed for i-carbon at 0.2120 nm and the calculated (003) glitter reflection at 0.1975 nm, has the only deviation which does not fit within 3Σₓ=0.0130 Å/reflection together with the rest of the dataset. In fact, this pair of matched reflections has a deviation of 0.0145 nm, as reflected in Table 1.

Clearly the close fit between the two datasets shown in Table 1 is a compelling reason to believe that perhaps the structure of i-carbon is that of the crystalline structure already proposed by us [9, 10] based upon theoretical grounds, and called glitter. What other reasons do we have for believing in the validity and uniqueness of the glitter structure as the structure of i-carbon in this instance, other than the close fit of the diffraction data?

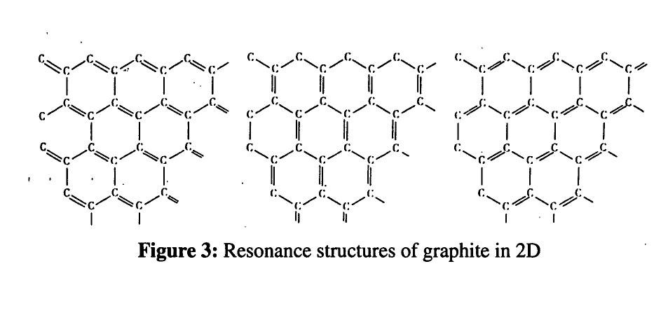

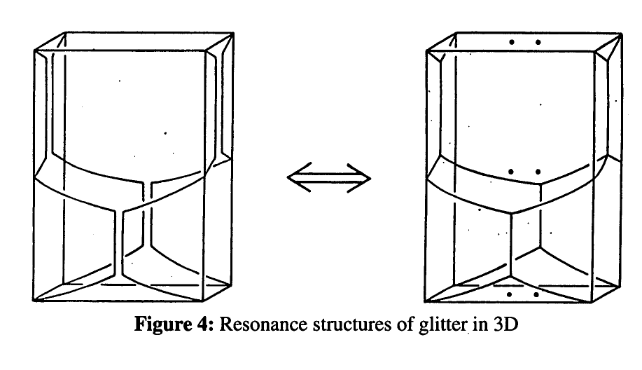

In a previous communication [10] we described the unique bonding character of glitter with regard to the possibility of writing resonance structures over the glitter structure in fully 3D. These resonance structures in 3D are completely analogous to the resonance structures that can be drawn over the graphite structure in 2D. The 3D, as well as the 2D, resonance structures can be viewed as a purely heuristic device that depend, for their illustration, on a consideration of the topological interaction and overlap of atomic p orbitals, within the symmetry adapted crystal orbitals for graphite and glitter. [18-20] Some of the possible graphite resonance structures are shown in FIG. 3 [21], while those of the glitter structure are shown in FIG. 4 [10].

The mechanism of resonance in 3D in glitter is spiroconjugation [10], while that operative in graphite in 2D is conjugation [21]. Conjugation has been abundantly described in the vast literature of organic chemistry [22], as it is ubiquitous in the description of structural stability of the aromatic hydrocarbons and fullerenes, and is used in connection with the description of organic reaction mechanisms as well. Indeed, it was Kekule who first proposed resonance structures for benzene in 1860. [23] Spiroconjugation, on the other hand, was only first described in 1968 by two groups working out its theory simultaneously. One of these theory groups that first proposed spiroconjugation was led by Hoffmann et al. at Cornell University [24] and the other theory group was led by Simmons et al. at DuPont Central Research & Development [25]. Subsequently, there have been numerous experimental observations of the effects of spiroconjugation in real molecular systems in terms of chemical reactivity, spectroscopic effects and other effects [26-36].

That spiroconjugation is present in glitter has already been described by Bucknum et al. [18, 19]. It has been shown that this effect leads to the closing of the band gap in the glitter structure, which creates a bona fide metallic carbon allotrope, as evidenced both by theoretical calculations at the semi-empirical extended Hueckel molecular orbital level (EHMO) [9], and by sophisticated high level calculations at the DFT level [11, 37]. The resonance structures that can be drawn over the glitter unit cell, as a consequence of the 3D spiroconjugation in it, lead to a unique stability for the material, akin to the stability of the aromatic hydrocarbons, fullerenes and graphite from their modes of conjugation [20-23]. It is therefore apparent that the glitter structure isn't just any ordinary 3D network that could be derived potentially from the space of plausible networks that are out there, but in fact this network is unique in its bonding character and with the resonance effects present in it, it is specially positioned to be a potential allotrope of C. So it should not be surprising that the diffraction data reported for glitter and i-carbon here, as well as that diffraction data comparison reported previously for glitter and n-diamond [10] discussed above, together provide internally consistent explanations for both of these observed nanometric carbon phases. It would thus appear from the analysis provided in this paper with respect to i-carbon, and the previous analysis with respect to n-diamond, that i-carbon and n-diamond are of the same structure and that this structure is given by its identification with the tetragonal glitter structure first proposed by Bucknum et al. in 1994 [9].

One point to be addressed, in all of this diffraction analysis, is that perhaps some other proposed structure of carbon, as referenced for example in [9, 10], could explain the diffraction evidence for n-diamond and i-carbon. To be consistent with the observed data on these carbon forms, one would have to have, in the tetragonal system, a lattice with the identical lattice parameters as glitter has, and in order that the structure is chemically reasonable, it would, by default, have to have the glitter structure itself. In the cubic system we have cubic diamond, which already reasonably explains the n-diamond diffraction evidence, although there are several symmetry forbidden reflections in the analysis. It would therefore seem, that in the cubic system we would have to have a lattice with the cubic diamond dimensions in order to explain the n-diamond half of the data, with no chance of explaining the i-carbon dataset. Alternatively, there are the hexagonal, trigonal, orthorhombic, monoclinic and triclinic systems. It is not clear, at this juncture, whether there is a carbon structure in these systems that is chemically reasonable and that explains both the n-diamond and i-carbon diffraction evidence reasonably well. We know that hexagonal diamond explains several of the n-diamond reflections. But it doesn't explain the i-carbon data like glitter does. Finally, there may be some potential graphite-diamond hybrid, as explained above, that could have a combination of the lattice parameters a, b and c that would explain the diffraction data of both of these quenchable forms of carbon within the orthorhombic system.

Above all, the lesson we have learned from the observed allotropes of C, is that it prefers to form crystalline structures that exist with high symmetry. Cubic diamond is in space group Fd3m, and hexagonal diamond is in P6₃/mmc, while graphite exists in the hexagonal space group P6₃/mmc, or alternatively in the rhombohedral space group R3m. In addition, the fullerenes are known to possess various levels of icosahedral symmetry, Iₕ. Therefore, the proposal of glitter here as the solution to the conundrum of the structural identity of n-diamond and i-carbon, is just a plausible proposal in the end. It is purely based upon a close fit of the diffraction data from experimental work of various investigators [1-8] with that calculated in a structural optimization reported here and in [10].

Finally, it should be noted that separate diffraction evidence for the synthesis of glitter from Novolac resin (a type of ordered Bakelite resin) under high temperature conditions and employing a heat-sensitive crosslinking agent called hexamethylenetetramine (HMTA), which descomposes to crosslinking and reactive methylene fragments on heating, has been reported by Stamatin et al. in 2004 [38]. This work on the synthesis of glitter from Novolac resin and HMTA is under continuing progress currently.

TABLE 1
Observed diffraction data of i-carbon compared to theoretical
diffraction data of P4₂/mmc tetragonal glitter

| calculated glitter | | | |
|---|---|---|---|
| reflections | | | |
| a = 0.2560 nm, | | experimental | absolute deviation |
| c = 0.5925 nm | | i-carbon reflections* | per reflection** |
| (hkl) | d-spacing, nm | d-spacing, nm | Δd-spacing, nm |
| 100 | 0.2560 | 0.2550 | 0.0010 |
| 001 | 0.5925 | | |
| 110 | 0.1810 | 0.1820 | 0.0010 |
| 101 | 0.2350 | | |
| 111 | 0.1731 | | |
| 200 | 0.1280 | 0.1300 | 0.0020 |
| 002 | 0.2963 | 0.3040 | 0.0077 |
| 102 | 0.1937 | | |
| 120 | 0.1145 | | |
| 201 | 0.1251 | | |
| 211 | 0.1124 | 0.1100 | 0.0024 |
| 221 | 0.08947 | 0.0906 | 0.0011 |
| 212 | 0.1068 | | |
| 222 | 0.08656 | | |
| 300 | 0.08533 | | |
| 003 | 0.1975 | 0.2120 | 0.0145 |
| 103 | 0.1564 | 0.1510 | 0.0054 |
| 130 | 0.08095 | | |
| 301 | 0.08446 | 0.08350 | 0.0010 |
| 311 | 0.08021 | | |
| 331 | 0.06003 | | |
| 313 | 0.07491 | | |
| 333 | 0.05771 | | |
| 203 | 0.1074 | | |
| 302 | 0.08200 | | |
| 320 | 0.07100 | | |
| 223 | 0.08228 | | |
| 232 | 0.06905 | | |
| 332 | 0.05912 | | |
| 323 | 0.06682 | | |
| 321 | 0.07050 | | |
| 312 | 0.07809 | | |
| 213 | 0.09905 | | |
| 104 | 0.1282 | | |
| 401 | 0.06363 | | |

*K. Yamada and A. B. Sawaoka, Carbon, 32(4), 665, (1994)
**average deviation over the 9 reflections compared is 0.0040 nm/reflection

TABLE 2
Crystallographic Coordinates of Glitter Based Upon the CASTEP-
DFT Optimization

| Atom# | x | y | z | a | c |
|---|---|---|---|---|---|
| 1 | 0 | 0 | 0 | 2.564Å | 5.928Å |
| 2 | 1.2820 | 0 | 0.8168 | ″ | ″ |
| 3 | 1.2820 | 0 | 2.1468 | ″ | ″ |
| 4 | 0 | 0 | 2.9640 | ″ | ″ |
| 5 | 0 | 1.2820 | 3.7808 | ″ | ″ |
| 6 | 0 | 1.2820 | 5.1108 | ″ | ″ |

1. I claim a novel allotrope of carbon having the unit of structure known in the art as the glitter structure-type in the form of nano- and microcrystalline carbon known as n-diamond and i-carbon in the art.

2. I claim the forms of the novel glitter allotrope described above in claim 1, as substitutional polymorphs in which C atoms in the lattice are replaced by other Group 14 elements (Si, Ge, Sn and Pb).

3. I claim the dynamic and static high pressure-high temperature techniques commonly known in the art for synthesizing diamond carbon forms, as methods of creating the glitter allotrope of carbon, as the n-diamond and i-carbon nano- and microcrystalline forms commonly known in the art.

4. I claim the methods of dynamic and static high pressure-high temperature synthesis, described in claim 3, and restricted to synthesis temperatures typical for diamond synthesis in the art and synthesis pressures typical for diamond synthesis in the art.

5. I claim the methods of dynamic and static high pressure-high temperature synthesis, described in claim 3, and in which a transition metal catalyst is employed.

6. I claim technological uses for the allotrope of carbon known as glitter, in the form of nano- and microcrystals of n-diamond and i-carbon.

7. I claim technological uses for the glitter allotrope of carbon in the form of n-diamond and i-carbon nano- and microcrystals, as described in claim 6, which include those applications which exploit its extreme hardness characteristics.

8. I claim technological uses for the glitter allotrope of carbon in the form of n-diamond and i-carbon nano- and microcrystals, as described in claim 6, which include those applications which exploit its novel conductivity applications.

9. I claim technological uses for the glitter allotrope of carbon in the form of n-diamond and i-carbon nano- and microcrystals, as described in claim 6, which include those applications which exploit its novel 3D spiroconjugation properties and those of its 1D and 2D substructures.
